(19) United States
(12) Patent Application Publication
(10) Pub. No.: US 2024/0291582 A1
(43) Pub. Date: Aug. 29, 2024

(54) SYSTEMS AND METHODS FOR AUTOMATIC CORRECTION FOR PTP DELAY ASYMMETRY

(71) Applicant: ARRIS Enterprises LLC, Horsham, PA (US)

(72) Inventor: Anand Kumar GOENKA, Bengaluru (IN)

(73) Assignee: ARRIS Enterprises LLC, Horsham, PA (US)

(21) Appl. No.: 18/444,467

(22) Filed: Feb. 16, 2024

Related U.S. Application Data
(60) Provisional application No. 63/448,332, filed on Feb. 26, 2023.

(51) Int. Cl. H04J 3/06

(52) U.S. Cl. CPC H04J 3/0667

(57) ABSTRACT

Systems and methods for adjusting for delay asymmetry between clocks in a communication network. Disclosed systems and methods may adjust data in one or more Sync and Delay Response Messages sent using the Precision Timing Protocol (PTP) based on one or more averages made of timing information in those Sync and Delay Response Messages.

### CROSS REFERENCE TO RELATED APPLICATIONS

This application claims the benefit of U.S. Provisional Patent Application Ser. No. 63/448,332 filed Feb. 26, 2023.

### BACKGROUND

The subject matter of this application generally relates to communications networks such as a CATV network, and more particularly relates to the synchronization of devices in such communications networks.

Although Cable Television (CATV) networks originally delivered content to subscribers over large distances using an exclusively RF transmission system, modern CATV transmission systems have replaced much of the RF transmission path with a more effective optical network, creating a hybrid transmission system where cable content terminates as RF signals over coaxial cables, but is transmitted over the bulk of the distance between the content provider and the subscriber using optical signals. Specifically, CATV networks include a head end at the content provider for receiving signals representing many channels of content, multiplexing them, and distributing them along a fiber-optic network to one or more nodes, each proximate a group of subscribers. The node then de-multiplexes the received optical signal and converts it to an RF signal so that it can be received by viewers. The system in a head end that provides the video channels to a subscriber typically comprises a plurality of EdgeQAM units operating on different frequency bands that are combined and multiplexed before being output onto the HFC network.

Historically, the head end also included a separate Cable Modem Termination System (CMTS), which is used to provide high speed data services, such as video, cable Internet, Voice over Internet Protocol, etc. to cable subscribers. Typically, a CMTS will include have both Ethernet interfaces (or other more traditional high-speed data interfaces) as well as RF interfaces so that traffic that is coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern HFC CATV systems have combined the functionality of the CMTS with the video delivery system (EdgeQAM) in a single platform called the Converged Cable Access Platform (CCAP).

As networks have expanded and head ends have therefore become increasingly congested with equipment, many content providers have recently used distributed architectures to spread the functionality of the CMTS/CCAP throughout the network. This distributed architecture keeps the cable data and video signals in digital format as long as possible, extending the digital signals beyond the CMTS/CCAP deep into the network before converting them to RF. It does so by replacing the analog links between the head end and the access network with a digital fiber (Ethernet/PON) connection.

One such distributed architecture is Remote PHY (R-PHY) distributed access architecture that relocates the physical layer (PHY) of a traditional CMTS or CCAP by pushing it to the network's fiber nodes. Thus, while the core in the CMTS/CCAP performs the higher layer processing, the R-PHY device in the node converts the downstream data sent by the core from digital to analog to be transmitted on radio frequency, and converts the upstream RF data sent by cable modems from analog to digital format to be transmitted optically to the core. Other such distributed architectures also exist e.g., Remote MACPHY architectures where both the physical and MAC layers are moved to fiber nodes, Remote OLT (Optical Line Terminal) architectures, etc.

Once the functionality of the CMTS/CCAP is divided between a core in the head end and various PHY devices throughout the network, however, protocols must be established to properly synchronize the core with the PHY devices. One ubiquitous such protocol is the IEEE1588 Precision Timing Protocol (PTP), which may ordinarily achieve a clock accuracy in the sub-microsecond range. PTP describes a hierarchical master-slave architecture in which a root timing reference, called a grandmaster, transmits synchronization information used by the clocks residing on its network segment. for clock distribution.

PTP protocols achieve synchronization based on a calculated round-trip delay between a master device and its slave, and this calculation assumes a symmetrical delay between the two devices. However, in many communications networks, what matters most is the one-way delay (or phase offset) between the master device and it's slave. Using the PTP protocol, the one-way delay is assumed to be half of the round trip delay, but oftentimes this is not accurate, meaning that there is delay asymmetry between the devices.

What is desired, therefore, are improved systems and methods for detecting delay asymmetry, calculating its magnitude, and compensating for it.

### BRIEF DESCRIPTION OF THE DRAWINGS

For a better understanding of the invention, and to show how the same may be carried into effect, reference will now be made, by way of example, to the accompanying drawings, in which:

FIGS. 1A and 1B show alternative communications architectures where a CCAP core is used to synchronously schedule transmissions to and from a plurality of cable modems, used to illustrate the benefits of the disclosed systems and methods.

FIG. 2 shows an exemplary Precision Timing Protocol (PTP) message exchange to synchronize two clocks and calculate delays in messages between the two.

FIG. 3 shows an exemplary plot of delay asymmetry as a function of time between the clocks of FIG. 2.

FIG. 4 shows a first exemplary method of detecting, and correcting for the type of delay asymmetry shown in FIG. 3.

FIG. 5 shows a second exemplary method of detecting and correcting for the type of delay asymmetry shown in FIG. 3.

### DETAILED DESCRIPTION

For purposes of the disclosure and the claims, the following terms are defined to as to more easily understand the subject matter described and claimed:

Master Clock: a clock that sends timing information to a slave clock for that clock to synchronize its time to that of the master clock.

Slave Clock: a clock that receives timing information from a master clock to synchronize its time to that of the master clock.

Grandmaster Clock: a clock that only operates as a master clock and is the source of time to the packet network:

MAP messages: messages sent by the CMTS containing bandwidth allocation maps (MAP). The MAP contains information that indicates when a cable modem can transmit and for how long. The CMTS needs to send MAP messages ahead of time, so the cable modem will not miss the transmit opportunity.

MAP advance time: The amount of time that the CMTS sends the MAP messages ahead of the transmit opportunity of a cable modem. The CMTS can compensate for differences between its time and the Remote PHY device (RPD) time (which is also the cable modem time) by making the MAP advance time larger.

For purposes of the present disclosure, an exemplary R-PHY architecture of an HFC network will be used to describe the systems and methods disclosed in the present application, though those of ordinary skill in the art will appreciate that other communications networks that require synchronization between clocks or other devise remote from each other, and in particular those that rely on Precision Timing Protocol (PTP) will also benefit by the disclosure contained herein.

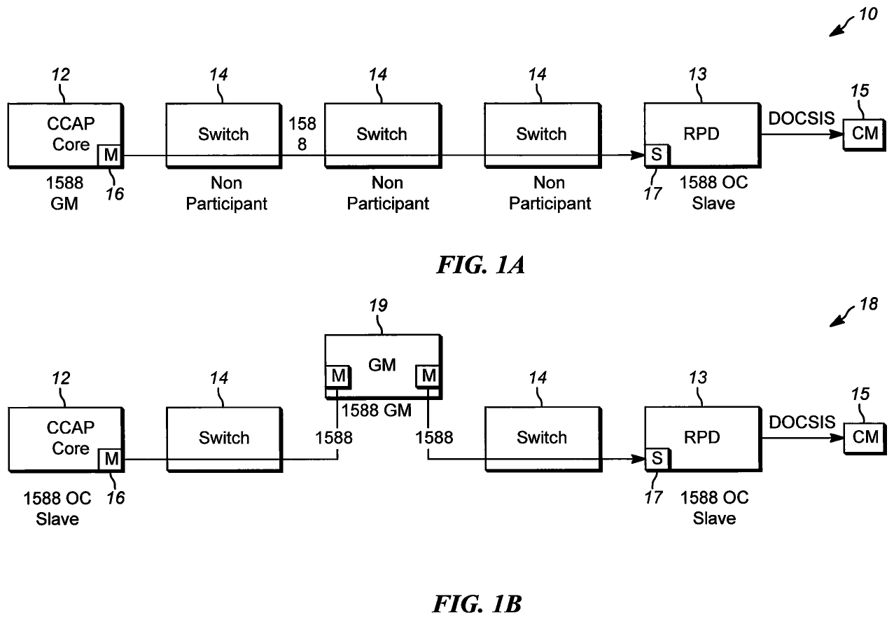

Referring first to FIG. 1A, an exemplary topology 10 used to synchronize the devices in an R-PHY architecture may include a CCAP core 12 synchronized with an RPD 13 connected together via a plurality of network switches 14. The RPD 13 is in turn connected to one or more cable modems 15. Synchronization is attained by a clock 16 in the core 12, acting as a grandmaster clock, which sends timing information to a slave clock 17 in the RPD 13. Those of ordinary skill in the art will appreciate that, although FIG. 1 shows only one RPD 13 connected to the core 12, many such RPDs may be simultaneously connected to the core 12, with each RPD having a slave clock 17 receiving timing information from the grandmaster clock 16 in the core. Those of ordinary skill in the art will also appreciate that an alternative timing architecture could include a separate grandmaster clock.

FIG. 1B shows an alternate topology 18, which differs from the topology 10 in that a separate grandmaster clock 19 is used to synchronize both the clock 16 in the core 12 and the clock 17 in the RPD 13. In this architecture, the clock 16 operates as a boundary clock where it is a slave to the grandmaster clock 19 but acts as a master clock to the slave clock 17 in the RPD 13.

As already noted, in many communications networks, the clocks of the devices in the network must be synchronized for time scheduling of data transfers to work properly, and this synchronization must not only be of frequency, but also of phase. As one example, to reduce interference among upstream transmissions, the CCAP core 12 operates as a MAC layer in an R-PHY system and is responsible for creating and sending periodic downstream MAP packets i.e., scheduling messages to the cable modems 15 so as to coordinate upstream transmissions among the network of cable modems 15. In turn, the cable modems 15 use the received MAP messages to determine when they may each gain access to the upstream channel and transmit packets in the upstream direction. These MAP messages must be received a sufficient amount of time before the transmission windows included in the MAP messages are scheduled to begin.

In another example, in Distributed Access Architectures for delivery of video content, two modes of video handling may be used-synchronous mode and asynchronous mode. Typically, network devices have hardware capable of operating in either mode, with software that enables configuration by a video core of itself and connected downstream devices into either alternate one of these modes when setting up video channels. In sync (synchronous) mode, the RPD (or RMD) and its video core are synchronized in time to the same reference clock. In this sync mode the RPD is required merely to detect lost video packets using the Layer 2 Tunneling Protocol v. 3 (L2TPv3) sequence number monitoring, and insert MPEG null packets for each missing packet. Thus, synchronization between the core and the remote device permits a relatively simple implementation where there is no requirement for any additional modifications to the video stream. Though an asynchronous (async) mode of operation may be employed, this requires significantly more processing in the remote device, which must be able to either insert or remove MPEG packets as necessary to maintain expected MPEG bitrate, and also adjust the MPEG PCR values due to the removal/insertion of the MPEG packets.

In both of these examples, what is technically to be achieved through synchronization is not only a frequency lock between the CCAP/core and the remote device to prevent timing drift between the two, but also the calculation of a phase offset between the core and the remote device. For example, a MAP message sent by a CCAP 12 must be received in time for the remote device to send an upstream transmission in it allotted time, hence the downstream delay from the CCAP 12 must be determined. Similarly, if a video core and a remote device are to operate in sync mode, they must be phase locked to a common reference clock.

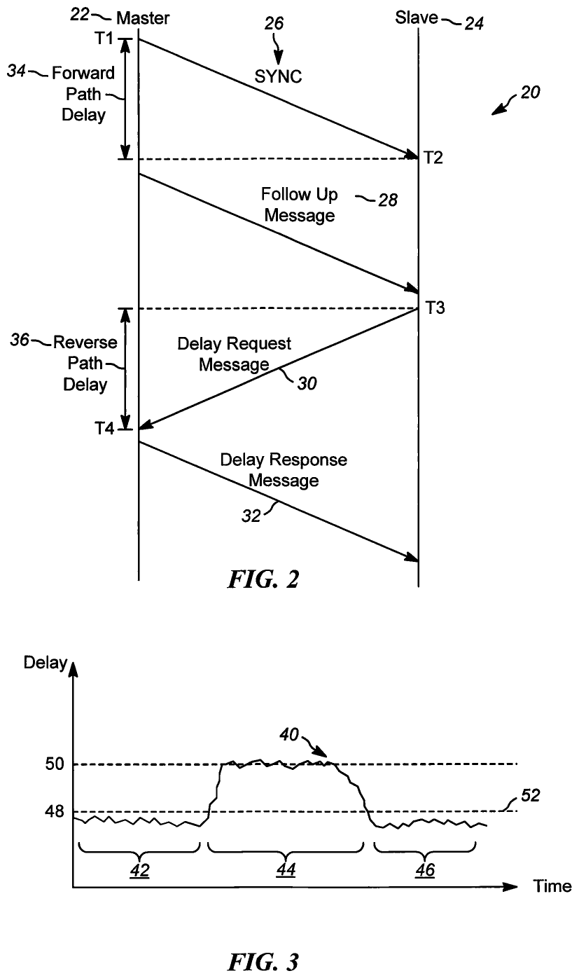

Typically, as noted above, IEEE 1588 Precision Timing Protocol (PTP) is used to lock a timing slave to a timing master, but this protocol adopts a timing lock based on a round trip delay on the assumption that the delays in either direction are symmetrical to each other. FIG. 2, for example, shows a system 20 in which a master clock 22 is locked to a slave clock 24 using a series of Sync and Delay Response messages. Specifically, at time t₁, the master clock 22 sends a Sync message 26 to the slave clock, which is received at time t₂. In some instances, the Sync message may include a timestamp within it indicating the time t1, while in other instances the master clock 22 will send a follow-up message 28 containing that time stamp. This latter embodiment is more accurate because the sync message with correspond with the time it was sent, without waiting for processing the sync message to write the time value into it.

Regardless of the manner in which the slave device 24 receives the timestamp indicating the time t₁, upon receipt the slave device 24 will send a Delay Request Message 30 at time t₃, which is received by the master clock 22 at time t₄. Then the master clock 22 sends to the slave clock 24 a delay response message 32, which includes the time t₄ that the Delay Request Message 30 was received. Based on these messages, the PTP protocol calculates the round-trip delay for messaging between the master clock 22 and the slave clock 24 as being [(T4−T1)−(T3−T2)]. Also according to the PTP protocol, each of the one-way delays from the master clock 22 to the slave clock 24, and vice versa, are assumed to be half of the round trip delay. This assumption is premised on the fact that there is no way, using only these messages, to determine either of the actual one-way delays since a calculation cannot circularly use these messages to define a synchronization “lock” and then use that defined synchronization lock to determine the individual forward and reverse path delays. Although there will always be asymmetry due to the differing paths and times that message exchanges traverse the path between these two clocks, thus encountering different buffering delays, processing times, etc., it is assumed that this asymmetry is small and that it varies randomly and averages to zero.

The present inventors realized, however, that oftentimes delay asymmetry is not random, and does not average to zero, particularly over short term, but not insignificant intervals. For example, delay asymmetry may result from packets traversing different paths in upstream and downstream direction due to temporary changes in network such as a power outage to a router/switch etc., and this delay asymmetry may last a sufficient amount of time to cause network issues such as missed MAP messages, etc. given that the one-way delay from a CMTS to a cable modem is longer than what was assumed by the CMTS when it sent the downstream MAP.

Referring again to FIG. 2, the slave device 24 may preferably use the PTP SYNC and Delay messages to calculate the forward (downstream) path delay 34 (t₂−t₁) and reverse (upstream) path delay 36 (t₄−t₃) between itself and the master device 22. These calculations may then be averaged over a desired “N” sequences of message exchanges. As just noted, when network conditions such as a malfunctioning router or switch cause asymmetry over a meaningful duration, the average asymmetry will increase noticeably. This is illustrated by FIG. 3, which shows a calculated average delay 40 measured over time. The delay 40 may represent an average of the forward path delay 34, or may represent the average of the reverse path delay 36. Specifically, during a first interval 42 the average delay 40 fluctuates randomly at a first level 48, but then during interval 44 rises significantly to a level 50 due to the network conditions just mentioned. When those network conditions are resolved, during interval 46 the average delay returns to its original level.

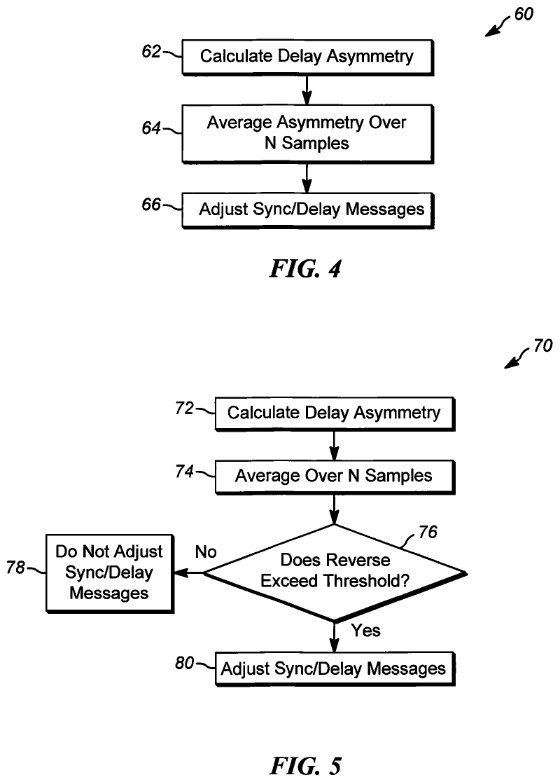

FIG. 4 shows a first embodiment of the present disclosure comprising a method 60 that corrects for changes in delay asymmetry of the type shown in FIG. 3. At step 62 respective delay asymmetry values are measured, using the messaging shown in FIG. 2 over an interval N. The delay asymmetry values mat be represented by ant appropriate metric. As one example, the delay asymmetry values may simply be calculated as the individual forward and reverse path delays 34, 36 shown in FIG. 2. Alternatively, a delay asymmetry value could represent the difference between the values 34, 36 or be represented by any other appropriate value or values that quantify the asymmetry between the forward and reverse path delays. The interval “N” may be any appropriate value, and in some embodiments may be configurable.

At step 64 the values measured in step 62 are averaged over the “N” samples. At step 66, the average is used to adjust or correct the values of the incoming SYNC messages and/or outgoing delay response messages. For SYNC messages, the calculated average path delay asymmetry is added to “Correction” field of PTP SYNC message. This is preferably done prior to the time that the slave's PTP protocol uses the timestamps and correction field from the PTP SYNC message for PTP-related calculations (e.g., the phase offset from master). Forr Delay Response messages, the calculated average path delay asymmetry is added to the “Correction” field of PTP Delay Response messages. This is preferably done prior to time that the slave PTP protocol uses the timestamps and correction field from the Delay Response message for PTP related calculation (e.g., calculation of mean path delay between master and slave). In both instances, the “average path delay asymmetry” is the average of the difference between the forward path delay and the reverse path delay over N samples. Thus, path delay asymmetry will a positive number if path delay from master to slave is longer than the path delay from slave to master.

FIG. 5 shows a second embodiment of the present disclosure comprising a method 70 that corrects for changes in delay asymmetry of the type shown in FIG. 3. At step 72 respective delay asymmetry values are measured, using the messaging shown in FIG. 2 over an interval N. The delay asymmetry values mat be represented by ant appropriate metric. As one example, the delay asymmetry values may simply be calculated as the individual forward and reverse path delays 34, 36 shown in FIG. 2. Alternatively, a delay asymmetry value could represent the difference between the values 34, 36 or be represented by any other appropriate value or values that quantify the asymmetry between the forward and reverse path delays. The interval “N” may be any appropriate value, and in some embodiments may be configurable.

At step 74 the values measured in step 62 are averaged over the “N” samples. At step 76 the computed average is compared to a threshold, such as the threshold 52 shown in FIG. 3. If the computed average is greater than the threshold, then at step 80 the average is used to adjust or correct the values of the incoming SYNC messages and/or outgoing delay response messages. If the computed average is not greater than the threshold, then the average is not used to adjust or correct the values of the incoming SYNC messages and/or outgoing delay response messages.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A device in a communications network having a local clock and operatively connected to a remote clock, the device engaging in Precision Timing Protocol (PTP) communications with the remote clock that include an exchange of Sync and Delay Response PTP messages, the device comprising a processor that modifies at least one of the Sync and Delay Response messages based upon at least one computed average of timing information included in a sequence of the PTP messages.

2. The device of claim 1 where the local clock is a slave clock and the remote clock is a master clock.

3. The device of claim 1 where the processor modifies the at least one of the Sync and Delay Response messages to correct for delay asymmetry between the local clock and the remote clock.

4. The device of claim 3 where the at least one computed average quantifies the delay asymmetry.

5. The device of claim 1 where the at least one computed average is compared to a threshold.

6. The device of claim 1 where the at least one computed average averages a one-way delay from the remote clock to the local clock.

7. The device of claim 1 where the at least one computed average averages a one-way delay from the local clock to the remote clock.

8. A method performed by a local clock and operatively connected to a remote clock via a communications network, the method comprising:
exchanging a sequence of Sync and Delay Response PTP messages with the remote clock;
computed at least one average of timing information included the sequence of the PTP messages; and
modifies at least one of the Sync and Delay Response messages based upon the at least one computed average.

9. The method of claim 8 where the local clock is a slave clock and the remote clock is a master clock.

10. The method of claim 8 including the step of modifying the at least one of the Sync and Delay Response messages to correct for delay asymmetry between the local clock and the remote clock.

11. The method of claim 10 where the at least one computed average quantifies the delay asymmetry.

12. The method of claim 8 including comparing the at least one computed average to a threshold.

13. The method of claim 8 where the at least one computed average averages a one-way delay from the remote clock to the local clock.

14. The method of claim 8 where the at least one computed average averages a one-way delay from the local clock to the remote clock.

15. A device in a network having a local clock and operatively connected to a remote clock, the device engaging in Precision Timing Protocol (PTP) communications with the remote clock that includes an transmission and/or receiving of Sync and Delay Response PTP messages, the device comprising a processor that modifies at least one of the transmission and/or receiving of Sync and Delay Response messages based upon at least one computed statistical measure of timing information included in a sequence of the PTP messages.
